(19) United States
(12) Patent Application Publication
(10) Pub. No.: US 2014/0104418 A1
(43) Pub. Date: Apr. 17, 2014

(54) IMAGE CAPTURING APPARATUS, CONTROL METHOD OF IMAGE CAPTURING APPARATUS, THREE-DIMENSIONAL MEASUREMENT APPARATUS, AND STORAGE MEDIUM

(71) Applicant: Toshinori Ando, Inagi-shi (JP)

(72) Inventor: Toshinori Ando, Inagi-shi (JP)

(73) Assignee: CANON KABUSHIKI KAISHA, Tokyo (JP)

(21) Appl. No.: 14/124,026

(22) PCT Filed: Jun. 7, 2012
(86) PCT No.: PCT/JP2012/065177

§ 371 Date: Dec. 5, 2013

(30) Foreign Application Priority Data
Jul. 8, 2011 (JP) 2011-152342

(51) Int. Cl. G01J 1/58; G06T 7/00; H04N 13/02

(52) U.S. Cl. CPC G01J 1/58; H04N 13/0271; G06T 7/0053
USPC 348/136

(57) ABSTRACT

An image capturing apparatus comprising; projection means for projecting a first or second pattern each having a bright and dark portions onto a target object as a projection pattern; and image capturing means for imaging the target object on an image sensor as a luminance distribution. The luminance distribution has a first luminance value corresponding to the bright portion and a second luminance value corresponding to the dark portion, the first and second patterns have an overlapping portion where positions of the bright or dark portion overlap, a first luminance distribution corresponding to the first pattern and a second luminance distribution corresponding to the second pattern have an intersection at which the luminance distributions have the same luminance value, and the luminance value at the intersection differs from an average value of the first and second luminance values by a predetermined value.

### TECHNICAL FIELD

The present invention relates to an image capturing apparatus that projects a pattern onto a subject and captures an image of the subject onto which the pattern is projected, a control method of the image capturing apparatus, a three-dimensional measurement apparatus, and a storage medium, and particularly relates to an image capturing apparatus that uses a method of projecting a plurality of patterns onto a subject, capturing images thereof, and calculating the position of a boundary between a bright portion and a dark portion in the images, a control method of the image capturing apparatus, a three-dimensional measurement apparatus, and a storage medium.

### BACKGROUND ART

Three-dimensional measurement apparatuses that acquire data on the three-dimensional shape of a subject by projecting a pattern onto the subject and capturing an image of the subject onto which the pattern is projected are widely known. The best known method is a method called a space encoding method, the principle of which is described in detail in the Journal of the Institute of Electronics, Information and Communication Engineers D, Vol. J71-D, No. 7, pp. 1249-1257. Also, Japanese Patent Laid-Open No. 2009-042015 discloses the principle of the space encoding method.

In conventional patterns shown in FIG. 13, blank portions indicate bright portions and hatched portions indicate dark portions, and in each of the pattern A and the pattern B, the front surface of a liquid crystal panel is divided into two parts, namely, the bright portions and the dark portions, and in both of the two patterns, the bright portions and the dark portions are reversed at a position indicated by arrow C. FIG. 2A shows luminance distributions and tone distributions in the case where these patterns are projected onto a subject and further projected onto an image sensor through an imaging optical system, which is not shown, of an image capturing unit. In FIG. 2A, the solid line represents a luminance distribution A on the image sensor corresponding to the pattern A shown in FIG. 13, and the dashed line represents a luminance distribution B on the image sensor corresponding to the pattern B. Moreover, a tone distribution A and a tone distribution B are each a series of numerical values obtained by sampling either the luminance distribution A or the luminance distribution B at each pixel of the image sensor. FIG. 3A is an enlarged illustration of the vicinity of a tone intersection C′ in FIG. 2A, and FIG. 3A shows that an intersection position C of the luminance distributions is obtained from the tone distributions using the method disclosed in the Journal of the Institute of Electronics, Information and Communication Engineers D, Vol. J71-D, No. 7, pp. 1249-1257. In other words, an intersection obtained by linearly interpolating the tone distributions in the vicinity of the intersection of the luminance distributions is calculated, and the position of the calculated intersection is indicated by C′ in FIG. 3A.

However, in FIG. 3A, there is clearly an error between the intersection C of the luminance distributions, which is the original intersection, and the intersection C′ of the tone distributions, and the purpose of precisely calculating the luminance distribution intersection is compromised. Moreover, this error changes depending on the position of the image sensor sampling the luminance distributions, and therefore is not uniquely determined and changes depending on the position and shape of a target object of measurement. Accordingly, a method in which, for example, the error is estimated in advance and corrected by calibration or the like cannot be used. Although it is possible to reduce this error by acquiring the tone distributions by sampling the luminance distributions in a more detailed manner, a high-density image sensor is necessary, which results in a decrease in an image capturing region of the image capturing unit. Alternatively, it is necessary to use a multi-pixel device to secure the image capturing region, resulting in a problem that an issue arises, such as a cost increase, an increase in size of the apparatus, or an increase in cost or a decrease in processing speed of the processing unit due to multi-pixel data to be processed.

### SUMMARY OF INVENTION

In light of the above-described problems, the present invention provides a technology that more accurately calculates an intersection with a small sampling number.

According to one aspect of the present invention, there is provided an image capturing apparatus comprising; a projection means for projecting a first pattern or a second pattern each having a bright portion and a dark portion onto a target object as a projection pattern; and an image capturing means for imaging the target object onto which the projection pattern is projected on an image sensor as a luminance distribution, wherein the luminance distribution has a first luminance value corresponding to the bright portion and a second luminance value corresponding to the dark portion, the first pattern and the second pattern have an overlapping portion where positions of the bright portion or positions of the dark portion overlap, a first luminance distribution corresponding to the first pattern and a second luminance distribution corresponding to the second pattern have an intersection at which the luminance distributions have the same luminance value in the overlapping portion, and the luminance value at the intersection differs from an average value of the first luminance value and the second luminance value by a predetermined value.

According to one aspect of the present invention, there is provided a control method of an image capturing apparatus, comprising: a projection step of projecting a first pattern or a second pattern each having a bright portion and a dark portion onto a target object as a projection pattern; and an image capturing step of imaging the target object onto which the projection pattern is projected on an image sensor as a luminance distribution, wherein the luminance distribution has a first luminance value corresponding to the bright portion and a second luminance value corresponding to the dark portion, the first pattern and the second pattern have an overlapping portion where positions of the bright portion or positions of the dark portion overlap, a first luminance distribution corresponding to the first pattern and a second luminance distribution corresponding to the second pattern have an intersection at which the luminance distributions have the same luminance value in the overlapping portion, and a luminance value at the intersection differs from an average value of the first luminance value and the second luminance value by a predetermined value.

Further features of the present invention will be apparent from the following description of exemplary embodiments with reference to the attached drawings.

### BRIEF DESCRIPTION OF DRAWINGS

FIG. 1 is a diagram showing projection patterns according to the present invention.

FIG. 2A is a diagram showing luminance distributions and tone distributions on an image sensor when conventional projection patterns are projected.

FIG. 2B is a diagram showing luminance distributions and tone distributions on an image sensor when the projection patterns according to the present invention are projected.

FIG. 3A is a diagram showing a luminance intersection and a tone intersection when the conventional projection patterns are projected.

FIG. 3B is a diagram showing a luminance intersection and a tone intersection when the projection patterns according to the present invention are projected.

FIG. 4 is a diagram showing a comparison between an intersection calculation error of the present invention and an intersection calculation error of a conventional example.

FIG. 5 is a diagram showing a relationship between the intersection calculation error and the height of the luminance intersection as well as the pixel density.

FIG. 6 is a diagram obtained by normalizing FIG. 5 using the value of a luminance intersection detection error when the height of the luminance intersection is 0.5.

FIG. 7 is a diagram showing how the intersection height is changed by shifting the luminance distribution of a pattern A relative to the luminance distribution of a pattern B.

FIG. 8 is a diagram showing how the value of the luminance intersection height is changed by reducing the imaging performance and thereby converting a luminance distribution A and a luminance distribution B into a luminance distribution A′ and a luminance distribution B′ in which the luminance changes more gently.

FIG. 9 is a diagram showing other projection patterns according to the present invention.

FIG. 10 is a diagram showing luminance distributions of the projection patterns in FIG. 9.

FIG. 11 is a diagram showing other projection patterns according to the present invention.

FIG. 12 is a diagram showing the configuration of a three-dimensional measurement apparatus.

FIG. 13 is diagram showing an example of conventional projection patterns.

FIGS. 14A to 14C are diagrams for explaining the principle of the present invention.

### DESCRIPTION OF EMBODIMENTS

Exemplary embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

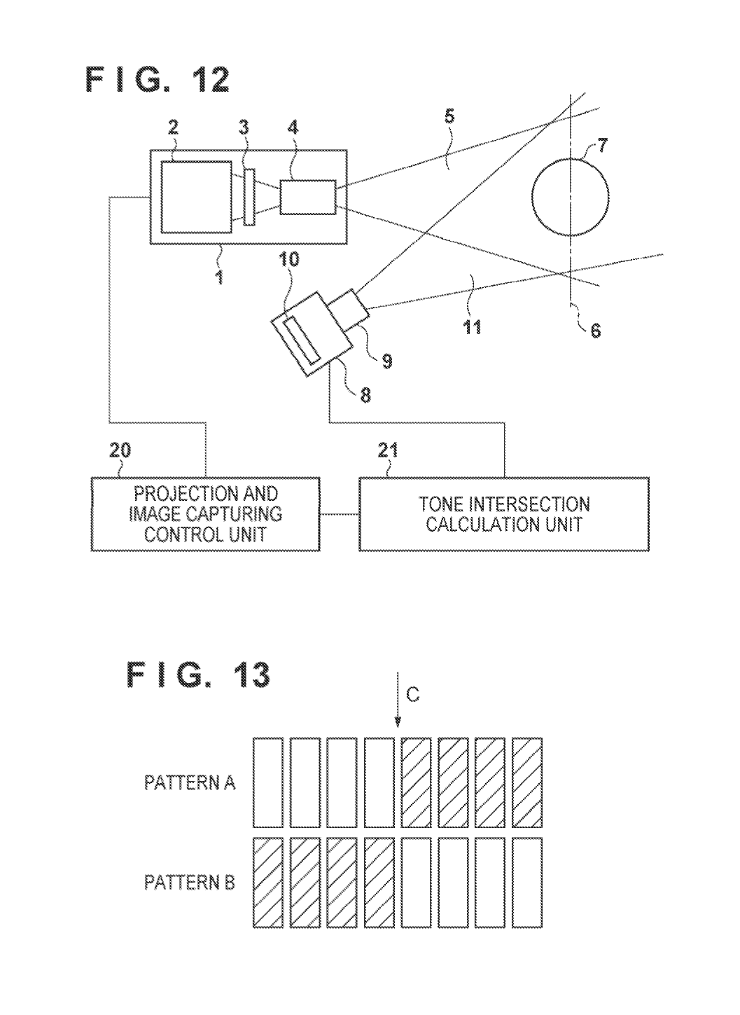

The configuration of a three-dimensional measurement apparatus will be described with reference to FIG. 12. The three-dimensional measurement apparatus includes a projection unit 1, an image capturing unit 8, a projection and image capturing control unit 20, and a tone intersection calculation unit 21. The projection unit 1 and the image capturing unit 8 constitute an image capturing apparatus configured to project a projection pattern onto a target object and capture an image of the projected pattern. The projection unit 1 includes an illumination unit 2, a liquid crystal panel 3, and a projection optical system 4. The image capturing unit 8 includes an image capturing optical system 9 and an image sensor 10. The three-dimensional measurement apparatus measures the position and the orientation of the target object using, for example, a space encoding method.

The projection unit 1 projects an image on the liquid crystal panel 3 illuminated by the illumination unit 2 via the projection optical system 4 onto a subject 7 disposed in the vicinity of a subject plane 6. The projection unit 1 projects a predetermined pattern onto the subject 7 in accordance with an instruction from the projection and image capturing control unit 20, which will be described later.

The image capturing unit 8 captures an image by imaging the pattern projected onto the subject 7 on the image sensor 10 as a luminance distribution via the image capturing optical system 9. The image capturing operation of the image capturing unit 8 is controlled in accordance with an instruction from the projection and image capturing control unit 20, which will be described later, and the image capturing unit 8 outputs the luminance distribution on the image sensor 10 to a tone intersection calculation unit 21, which will be described later, as a discretely sampled tone distribution. The projection and image capturing control unit 20 directs the projection unit 1 to project a predetermined pattern onto the subject 7 at a predetermined timing and directs the image capturing unit 8 to capture an image of the pattern on the subject 7.

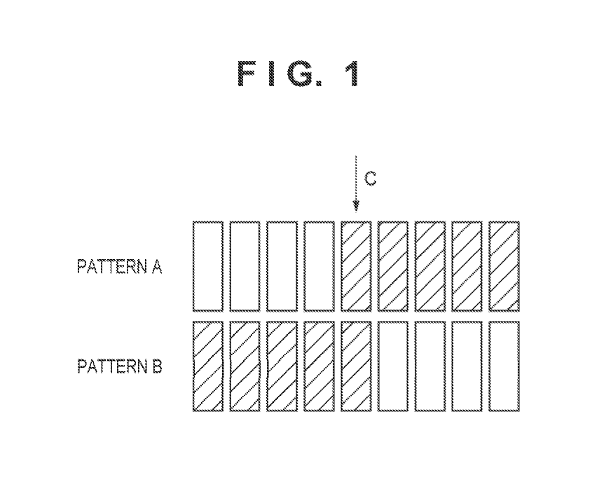

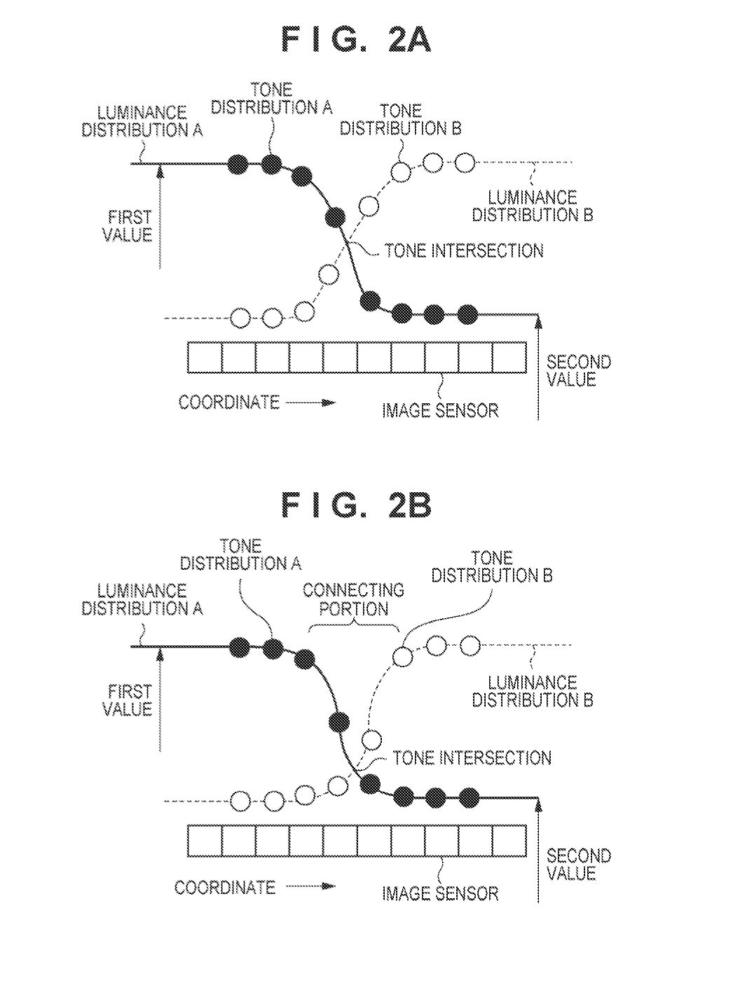

FIG. 1 shows a pattern A (first pattern) and a pattern B (second pattern) which are projected by the projection and image capturing control unit 20 and each of which indicates brightness and darkness of individual liquid crystal pixels. In FIG. 1, blank portions indicate bright portions and hatched portions indicate dark portions, and the pattern A and the pattern B are each composed so that the front surface of the liquid crystal panel is divided into two parts, namely, the bright portions and the dark portions, and the position of the bright portions and the position of the dark portions of the two patterns are reversed. Moreover, the two patterns have a bright or dark portion in common, the bright or dark portion corresponding to at least a predetermined number of pixels. In the case of FIG. 1, the pattern A and the pattern B have an overlapping portion where the two patterns have a dark portion in common at a position indicated by arrow C. In a projection pattern position detection operation, first, the projection and image capturing control unit 20 directs the projection unit 1 to project the pattern A in FIG. 1 onto the subject 7 and directs the image capturing unit 8 to capture an image of the subject 7 onto which the pattern A is projected. Then, the projection and image capturing control unit 20 directs the image capturing unit 8 to output a luminance distribution on the image sensor 10 to the tone intersection calculation unit 21 as a discretely sampled tone distribution A.

Similarly, projection and image capturing operations for the pattern B are performed, and a luminance distribution on the image sensor 10 is output to the tone intersection calculation unit 21 as a discretely sampled tone distribution B corresponding to the pattern B.

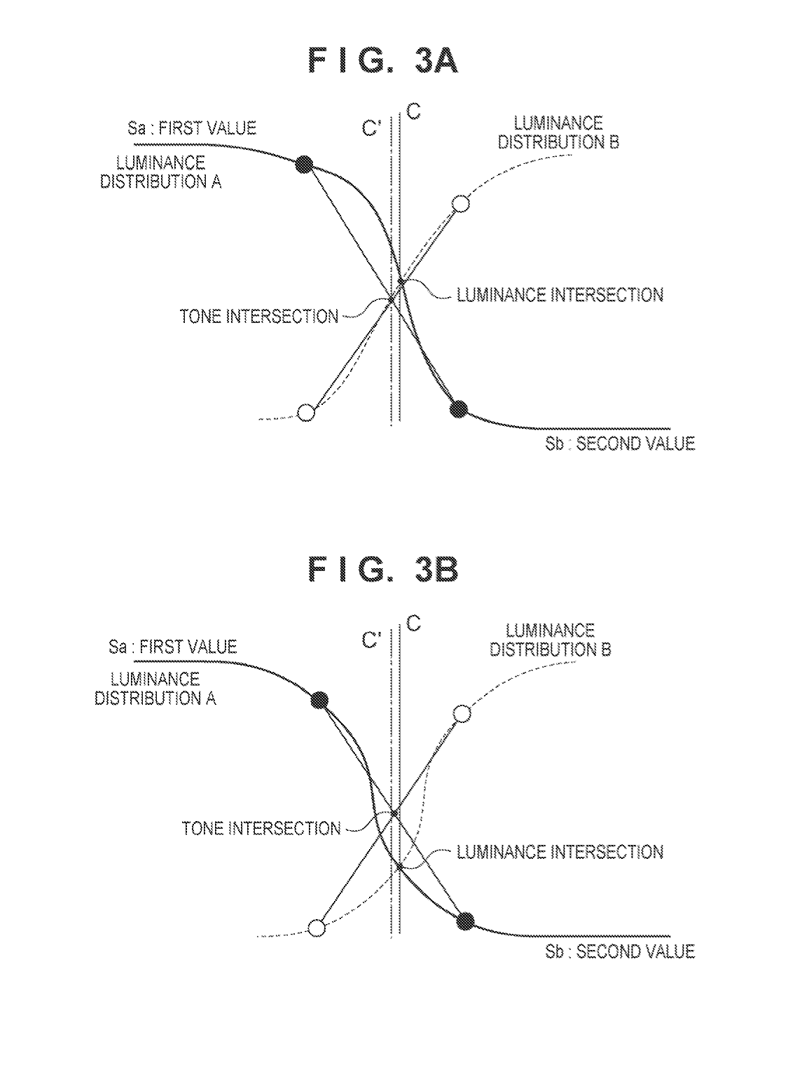

FIG. 3B is a diagram for explaining the thus obtained luminance distributions and tone distributions. In FIG. 3B, the solid line represents the luminance distribution A on the image sensor 10 corresponding to the pattern A, and the dashed line represents the luminance distribution B on the image sensor 10 corresponding to the pattern B. Moreover, the tone distribution A and the tone distribution B are each a series of numerical values obtained by sampling either the luminance distribution A or the luminance distribution B at individual pixels of the image sensor 10. A first luminance value Sa is a tone value corresponding to the bright portions of the pattern A and the pattern B, and similarly, a second luminance value Sb is a tone value corresponding to the dark portions of the pattern A and the pattern B. It should be noted that not only the pattern configurations but also the surface texture of the subject 7 affects the distributions of these values. For this reason, to determine the configuration of the apparatus of the present invention, the determination can be performed in a state in which a standard flat plate or the like having a uniform reflectance is placed on the subject plane 6 in FIG. 12 or otherwise assuming this state. As shown in FIG. 3B, the tone distribution A and the tone distribution B are each composed of a portion having the above-described first luminance value Sa, a portion having the second luminance value Sb, and a connecting portion connecting those portions to each other. Moreover, the two distributions have the same value at a position in the connecting portion, and this position will be referred to as an intersection. In the present specification, an intersection of the luminance distributions, which are images, will be referred to as a luminance intersection, and an intersection obtained from the discrete tone distributions will be referred to as a tone intersection. The tone intersection can be obtained by separately performing linear interpolation of the tone distribution A and the tone distribution B at a position where the magnitude of these tone distributions is reversed and calculating an intersection of the interpolated distributions. Alternatively, the tone intersection may be obtained by obtaining a difference distribution by subtracting the tone distribution B from the tone distribution A, and calculating the zero point of this difference distribution by performing linear interpolation as well.

In a conventional example, since patterns shown in FIG. 13 are projected, the value of the luminance intersection of the two luminance distributions is located midway between the first luminance value Sa and the second luminance value Sb as shown in FIG. 3A. However, in the present embodiment, since the patterns to be projected are set as shown in FIG. 1, the tone intersection of the tone distribution A and the tone distribution B is a value close to the tone value of the dark portions, that is, the second tone value Sb, rather than being located at the middle point (average value) of the luminance of the bright portions and the luminance of the dark portions as shown in FIG. 3B.

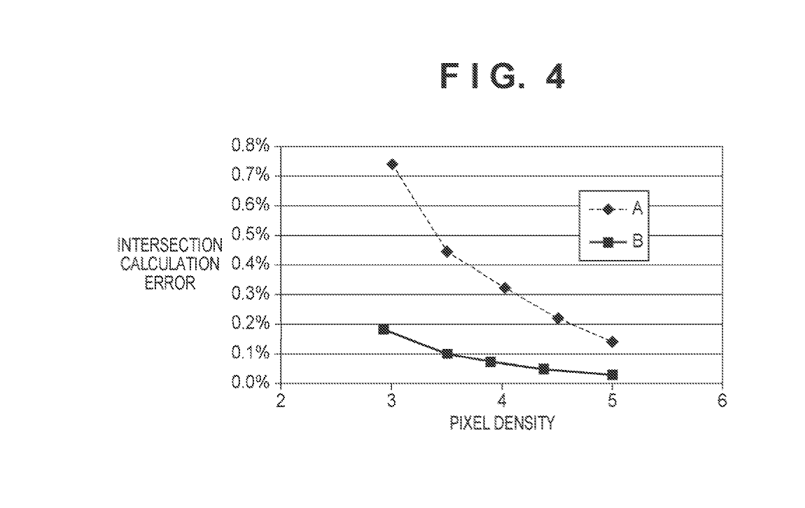

An effect of reducing an intersection calculation error in the case where the patterns according to the present embodiment are projected was obtained by simulation. FIG. 4 shows the result. FIG. 4 shows changes in the intersection calculation error with respect to the sampling density of the image sensor 10. The horizontal axis represents the sampling density. If the second luminance value Sb of the luminance distributions is taken as 0% and the first luminance value Sa is taken as 100%, a 10%-90% width Wr therebetween is defined by an expression (1) below, and the number of image capturing pixels within the range of that width is used as the pixel density.

(Sa+Sb)/2−(Sa−Sb)×0.4≦Wr≦(Sa+Sb)/2+(Sa−Sb)×0.4 (1)

The vertical axis represents the intersection calculation error, and an error between the luminance intersection position C and the tone intersection position C′ is shown as a percentage of Wr. In FIG. 4, dashed line A indicates an intersection calculation error for the conventional patterns, and solid line B indicates an intersection calculation error in the case where the value of the height of the tone intersection is set to a position at about 20% in the range between the first luminance value Sa and the second luminance value Sb. The intersection calculation error decreases in the case where the present invention is carried out. In particular, the decrease in the intersection calculation error is significant at pixel densities on the horizontal axis of 4 and lower. That is to say, it is found that the error can be reduced even if the sampling number (the number of image capturing pixels) is small.

FIG. 5 is a graph showing how the intersection calculation error changes with the height of the luminance intersection and the pixel density. The height of the luminance intersection here is the value of the luminance intersection C in the case where the first luminance value Sa is used as a reference. The height of the luminance intersection is represented by the horizontal axis, and the luminance intersection detection error is represented by the vertical axis. In FIG. 5, a set of points in the case where the height of the luminance intersection is 0.5, which is located in the middle, represents a conventional system. Parameters 2.9, 3.5, 3.9, 4.4, and 5.0 each indicate the number of image capturing pixels (pixel density) within the range of the width Wr.

Moreover, FIG. 6 is a diagram obtained by normalizing the result in FIG. 5 using the luminance intersection detection error value (vertical axis) at the time when the height of the luminance intersection (horizontal axis) is 0.5. In other words, the luminance intersection detection error at the time when the height of the luminance intersection is 0.5 is taken as a reference value of 1.0. The height of the luminance intersection is represented by the horizontal axis, and as is clear from FIG. 6, at any pixel density (2.9, 3.5, 3.9, 4.4, and 5.0), the error is at its maximum when the height of the luminance intersection is 0.5, which means the conventional system, in a range of the height of the luminance intersection (horizontal axis) from 0.1 to 0.9. Then, it is found that the absolute value of the error is 0 when the height of the luminance intersection is in the vicinity of 0.2 and in the vicinity of 0.8. Moreover, when the height of the luminance intersection is within a range of 0.5±0.15, the error is slightly reduced, and when this range is exceeded, the error is significantly reduced. Furthermore, it is found that the error is worsened as compared to that of the conventional system when the height of the luminance intersection is 0.1 or less or 0.9 or more. That is to say, it is desirable that the height of the luminance intersection is 0.1 or more or 0.9 or less, and it is further desirable that the height of the luminance intersection is between 0.15 and 0.85 inclusive and other than 0.5±0.15 in view of a margin for fluctuation due to disturbance. Accordingly, in this case, it is desirable that the height of the luminance intersection is within a range of about 0.15 to 0.35 or 0.65 to 0.85.

That is to say, it is preferable that a relationship 0.15≦(Sc−Sb)/(Sa−Sb)≦0.35 or 0.65≦(Sc−Sb)/(Sa−Sb)≦0.85 is fulfilled, where Sa represents the first luminance value, Sb represents the second luminance value, and Sc represents the luminance value at the intersection. Furthermore, it is further preferable that a relationship (Sc−Sb)/(Sa−Sb)=0.2 or (Sc−Sb)/(Sa−Sb)=0.8 is fulfilled.

Although the values of the luminance distributions were used in the foregoing description, if the luminance and the tone are associated with each other, the present invention may also be realized using values of the tone distributions after sampling by the image sensor. However, in the case where the height of the luminance intersection is set to 0.5 or more, if a subject having an excessive reflectance is used, there is a possibility that an image exceeding a saturation luminance of the image sensor may be formed and calculation of the intersection of the tone distributions cannot be performed. To avoid such a situation, it is preferable that the height of the luminance intersection is set to 0.5 or less.

Principle

Hereinafter, the principle on which the intersection position detection accuracy is improved by setting the intersection luminance to a value other than the middle point (average value) between the first luminance value Sa and the second luminance value Sb (i.e., a value offset from the average value by a predetermined value) will be described. In cases of calculating a position at which two different tone distributions have the same luminance value, it is possible to linearly interpolate between values at discrete positions in the tone distributions and calculate an intersection of the two straight lines respectively obtained from the two different tone distributions. Alternatively, it is also possible to separately obtain a difference distribution by calculating differences between the two different tone distributions, linearly interpolate the difference distribution as well, and calculate a position at which the value of the straight line is 0. The above-described two types of methods mathematically have the same meaning. A major cause of an error that occurs in cases where processing is performed by linearly interpolating any distribution is deviation from a straight line of the original distribution. The deviation from the straight line of the original distribution can be expressed as the magnitude of curvature in the deviating portion. That is to say, if the curvature is large, the curve is large and the deviation from the straight line is large, and if the curvature is small, the curve is small and close to a straight line, so that the deviation is small. Furthermore, since the final calculated intersection position is obtained from the difference distribution, even if the two tone distributions partially have a large curvature, there would be no problem if the curvatures of the two tone distributions cancel each other out when the differences of the tone distributions are calculated.

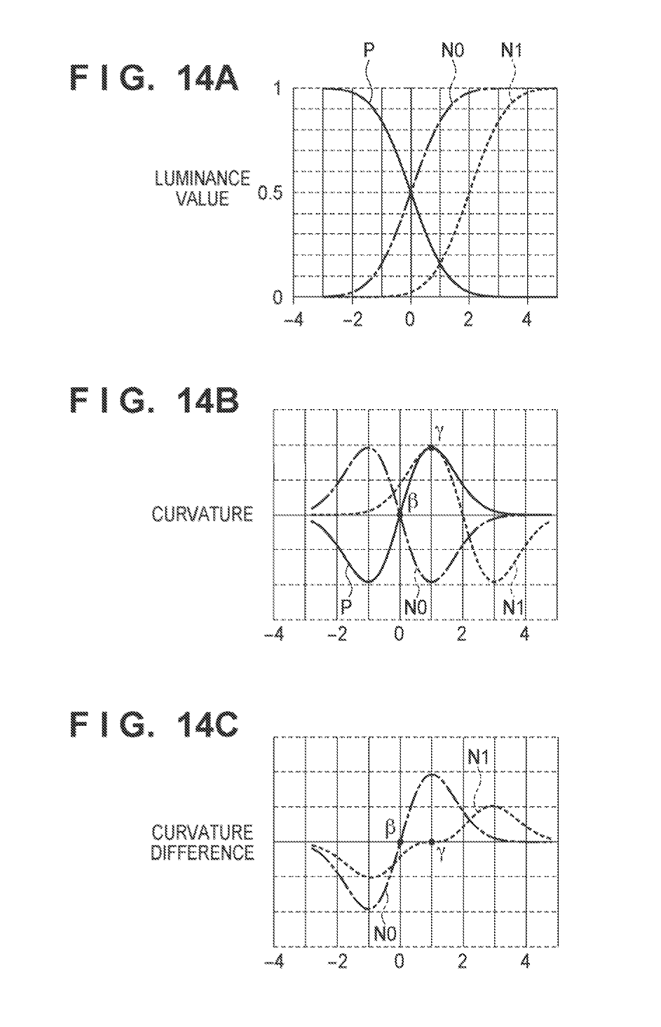

Hereinafter, the above-described principle will be described in detail with reference to FIGS. 14A to 14C. FIG. 14A shows an intersection portion of luminance distributions of edge images or lattice images of two patterns. In this example, a cumulative distribution function of normal distribution is used as a mathematical model, and coordinates on the horizontal axis are expressed in units of standard deviation. The vertical axis represents relative luminance values in the case where the first luminance value Sa is taken as 1.0 and the second luminance value Sb is taken as 0. The basis for using the above-described function as a model of the intersection portion of the edge images or the lattice images is that the above-described function is suitable for expression of an actual state of imaging in the following respects.
(1) The first luminance value Sa and the second luminance value Sb are connected by a smooth line.
(2) The two distributions are approximately equal with regard to the interchangeability of the left side and the right side of the coordinate system in the vicinity of the intersection.
(3) The curvature change has an “S” shape. That is to say, the curvature is 0 at the position of the middle point, and the curvature has opposite signs and has extreme values on opposite sides of that position.

In FIG. 14A, the solid line represents the first luminance distribution (corresponding to the pattern A in FIG. 1), which will be referred to as a P distribution. On the other hand, the long-short dashed line represents a conventional first luminance distribution intersecting the first luminance distribution at the half value (0.5), which will be referred to as an NO distribution. P and NO have an intersection at the zero coordinate on the horizontal axis. Moreover, the dashed line represents the second luminance distribution (corresponding to the pattern B in FIG. 1) according to the present invention also intersecting the first luminance distribution at a value other than the half value (0.5), and this distribution will be referred to as an N1 distribution. P and N1 have an intersection α at a coordinate value 1 on the horizontal axis, and the value of the intersection at this time is about 0.15.

FIG. 14B shows curvature distributions indicating a curvature change of the luminance distributions P, N0, and N1 in FIG. 14A, and the solid line, the long-short dashed line, and the dashed line are associated with the luminance distributions in the same manner as in FIG. 14A. The horizontal axis represents standard deviation, and the vertical axis represents the curvature of the luminance distributions. P and N0 have an intersection β at 0 on the horizontal axis and have an equal curvature of 0 at this position, but the curvature of P increases as the value on the horizontal axis increases, whereas the curvature of N0 decreases as the value on the horizontal axis increases. P and N1 have an intersection γ at 1 on the horizontal axis. In the vicinity of this position, the curvatures of P and N1 are almost equal, and are close to an extreme value of curvature and accordingly change gently.

FIG. 14C shows a curvature change of difference distributions each obtained from two luminance distributions, and the long-short dashed line represents a difference distribution obtained by subtracting N0 from P, which is the conventional luminance distribution, and the dashed line represents a difference distribution obtained by subtracting N1 from P. As is clear from FIG. 14C, even though the curvature of the difference distribution obtained by subtracting N0 from P is 0 at the intersection β, the absolute value of the curvature sharply increases with distance from this position. This indicates that in the vicinity of this position, the curve component between two points apart from each other is large and there is a strong possibility that a significant error may occur in a straight line approximation. In contrast, the curvature of the difference distribution obtained by subtracting N1 from P is 0 at the intersection position γ at 1 on the horizontal axis 1, and the absolute value of the curvature remains small over a wide range centered on this intersection position. This indicates that in the vicinity of this position, the curve component between two points apart from each other is small and a favorable straight line approximation is obtained.

For the reasons above, setting an intersection of two edge images or lattice images at a position in the vicinity of an extreme value of curvature, where the curvature change is gentle, improves the linearity of a difference distribution in the vicinity of the intersection and therefore enables accurate intersection detection to be performed even if a straight line approximation is used. That is to say, it is preferable that the position of the intersection is set to a position at which the curvature change of the curvature distribution of the first luminance distribution and the curvature change of the curvature distribution of the second luminance distribution are both smaller than a predetermined value and at an extreme value.

Method for Controlling Luminance Intersection: Relative Position Control of Projection Patterns

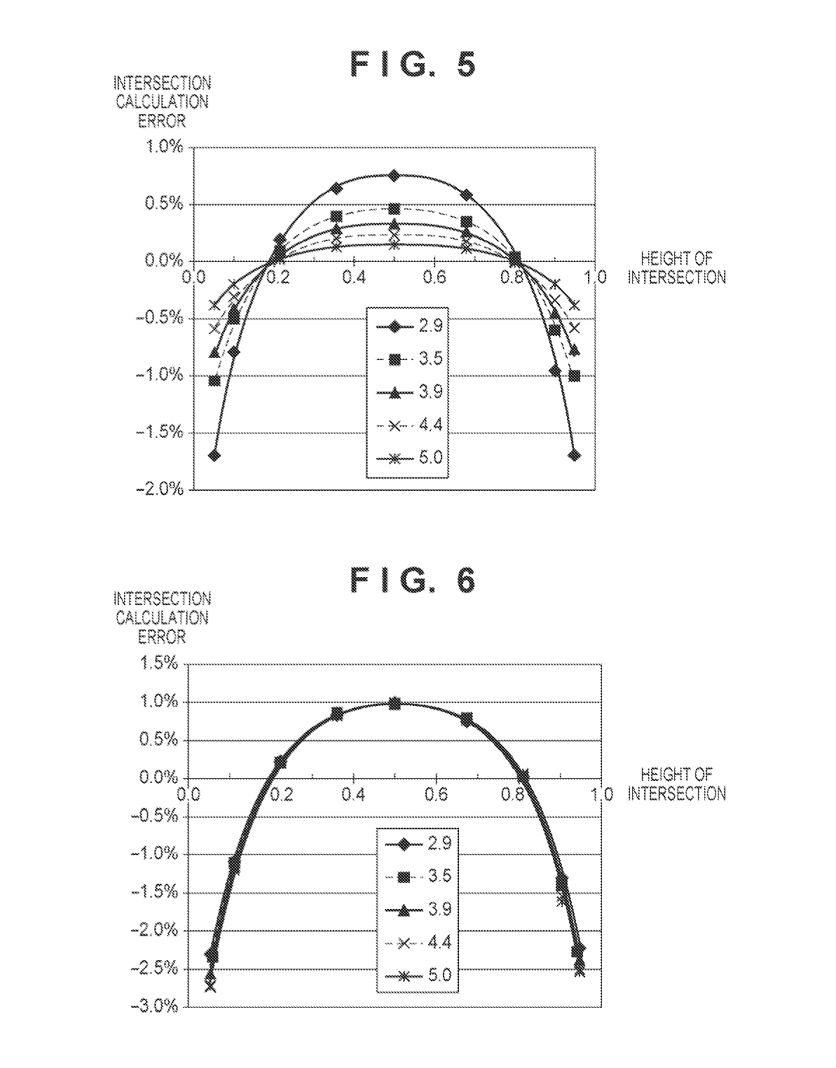

A method for controlling the height of the intersection will be described below. In FIG. 1, it is assumed that the pattern A and the pattern B have the dark portion in common, which corresponds to only a single pixel of the liquid crystal panel; however, it is also possible to set the height of the luminance intersection to 0.5 or more by the two patterns having a bright portion in common. In FIG. 1, it is assumed that the two patterns have the same luminance for a width corresponding to only a single pixel; however, it is possible to control the value of the height of the intersection by increasing or decreasing this width. Moreover, it is possible to control the value of the height of the intersection by performing projection while sequentially disposing knife-edges for the pattern A and the pattern B at the position of the liquid crystal panel, and relatively changing the distance between the knife-edges. FIG. 7 shows how the height of the intersection is changed by moving the luminance distribution of the pattern A relative to the luminance distribution of the pattern B. It can be seen from FIG. 7 that changing the luminance distribution of the pattern A to, for example, a pattern A 701, a pattern A 702, a pattern A 703, and a pattern A 704 results in a change in the height of the intersection to an intersection 711, an intersection 712, an intersection 713, and an intersection 714, respectively.

Method for Controlling Luminance Intersection: Change in Optical System Imaging Performance

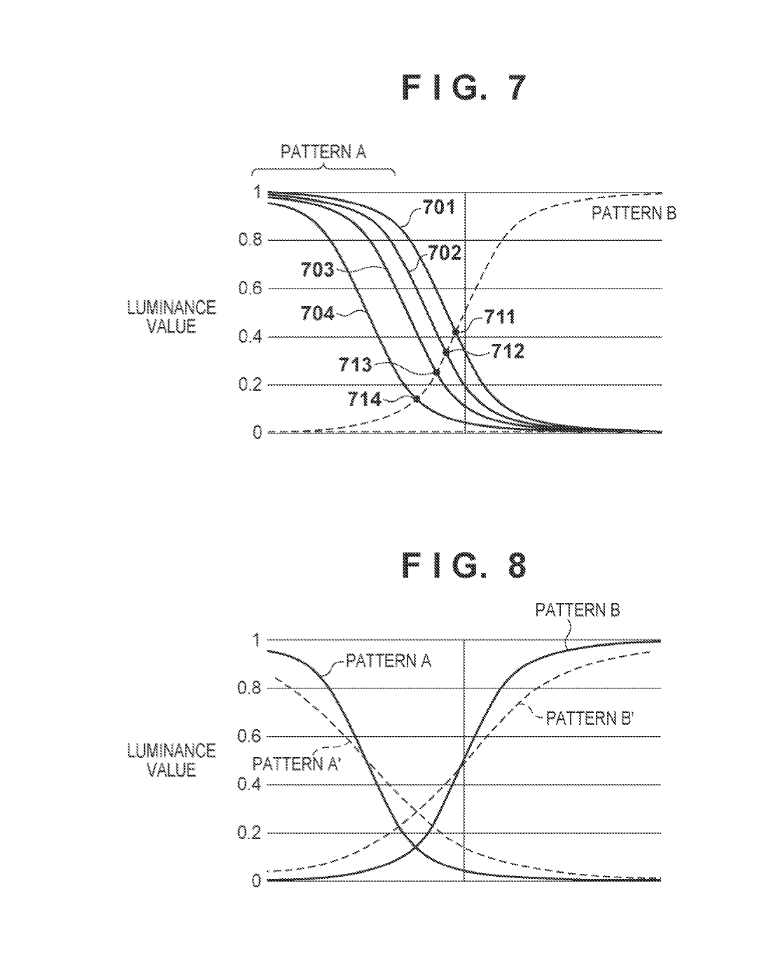

Moreover, it is also possible to change the height of the intersection by changing the imaging performance of the projection optical system or the image capturing optical system. To control the imaging performance, a method of generating an aberration by design or a method of, for example, generating a predetermined blur using a pupil filter or the like can be used. FIG. 8 shows a state in which the value of the height of the luminance intersection is changed by reducing the imaging performance and thereby changing the luminance distribution A (pattern A) and the luminance distribution B (pattern B) to a luminance distribution A′ (pattern A′) and a luminance distribution B′ (pattern B′) in which the luminance change is more gentle. However, since a change in focus and a change in resolution usually do not influence the position of the middle point of edge images, this method is not effective in the conventional system having the intersection at the middle point.

Change of Patterns

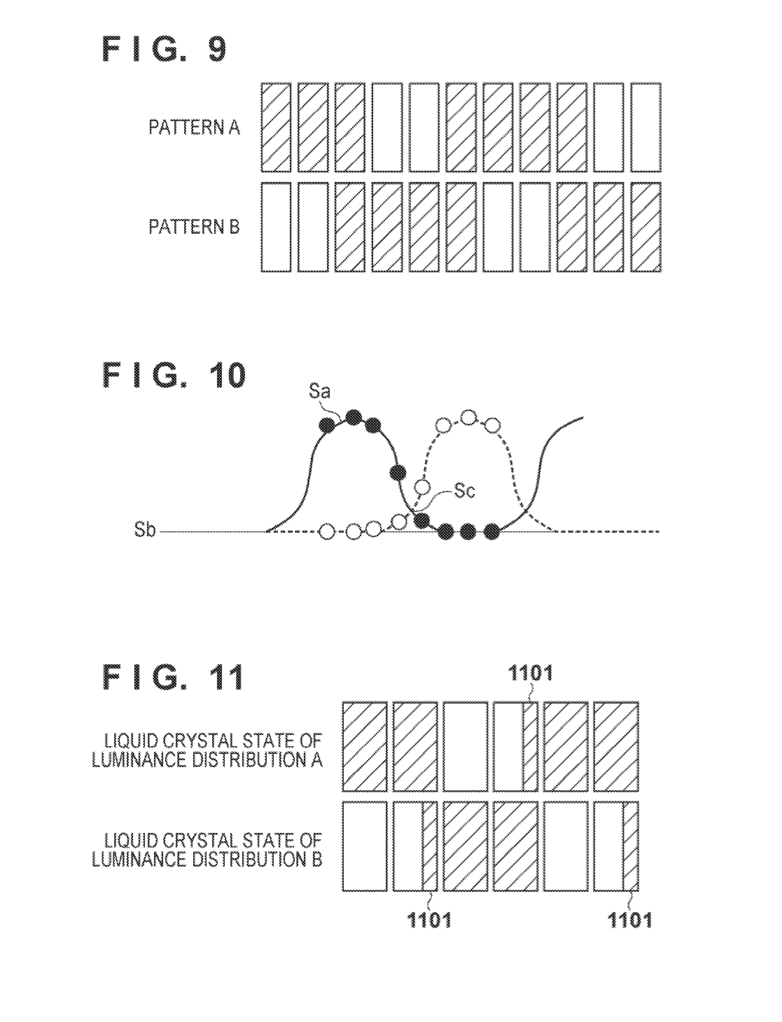

The foregoing description was provided on the assumption that the patterns are edge images, but this assumption was made merely to simplify the description, and the same effect of the present invention is obtained by using not only edge images but periodically repeated patterns as shown in FIG. 9 in which the width of the bright portions and the width of the dark portions are different from each other. This is because even when such repeated patterns are used, the behavior in an intersection portion thereof is the same as the phenomenon at an edge intersection. In the example shown in FIG. 9, a pattern A and a pattern B have common portions in the dark portions. FIG. 10 shows luminance distributions on the image sensor in the case of repeated patterns as shown in FIG. 9. In FIG. 10, Sa represents a value corresponding to the luminance of the bright portions and Sb represents a value corresponding to the luminance of the dark portions, and the value of the height of the luminance Sc at the intersection can be configured in the above-described manner.

Use of Disclination

In cases of pattern projection using liquid crystals, although control of the intersection position using brightness and darkness of liquid crystal pixels has been described, the present invention can also be carried out by using a liquid crystal non-transparent portion due to disclination, as shown FIG. 11. That is to say, in FIG. 11, there are non-transparent portions 1101 in a liquid crystal state providing a luminance distribution A and a liquid crystal state providing a luminance distribution B. Use of the non-transparent portions 1101 as overlapping portions of dark portions has the same effect as patterns such as those described with reference to FIGS. 1 and 9.

Use of Color Patterns, Shading Correction

Although the foregoing description was provided on the assumption that two patterns are sequentially projected, the present invention may also be realized by projecting two patterns in mutually different colors and performing color separation in the image capturing unit. In this case, there is a problem that the luminance of the two colors with respect to bright portions and dark portions, that is, the first luminance value and the second luminance value in the foregoing description, varies on the color-by-color basis depending on the spectral sensitivity of the target object or the sensor, the light source color, and the like. This problem can be solved by storing for each color a tone distribution obtained by projecting a uniform bright portion pattern onto the subject and capturing an image, and performing so-called shading correction that normalizes the tone using the stored tone distributions during calculation of the intersection.

According to the present invention, an intersection can be more accurately calculated with a small sampling number.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-152342 filed on Jul. 8, 2011, which is hereby incorporated by reference herein in its entirety.

1. An image capturing apparatus comprising;
a projection means for projecting a first pattern or a second pattern each having a bright portion and a dark portion onto a target object as a projection pattern; and
an image capturing means for imaging the target object onto which the projection pattern is projected on an image sensor as a luminance distribution,
wherein the luminance distribution has a first luminance value corresponding to the bright portion and a second luminance value corresponding to the dark portion, the first pattern and the second pattern have an overlapping portion where positions of the bright portion or positions of the dark portion overlap, a first luminance distribution corresponding to the first pattern and a second luminance distribution corresponding to the second pattern have an intersection at which the luminance distributions have the same luminance value in the overlapping portion, and the luminance value at the intersection differs from an average value of the first luminance value and the second luminance value by a predetermined value.

2. The image capturing apparatus according to claim 1,
wherein a relationship 0.15≦(Sc−Sb)/(Sa−Sb)≦0.35 or 0.65≦(Sc−Sb)/(Sa−Sb)≦0.85 is fulfilled, where Sa represents the first luminance value, Sb represents the second luminance value, and Sc represents the luminance value at the intersection.

3. The image capturing apparatus according to claim 2,
wherein a relationship (Sc−Sb)/(Sa−Sb)=0.2 or (Sc−Sb)/(Sa−Sb)=0.8 is fulfilled, where Sa represents the first luminance value, Sb represents the second luminance value, and Sc represents the luminance value at the intersection.

4. The image capturing apparatus according to any one of claims 1 to 3,
wherein the number of image capturing pixels within a range of (Sa+Sb)/2−(Sa−Sb)×0.4≦Wr≦(Sa+Sb)/2+(Sa−Sb)×0.4 is four or less, where Sa represents the first luminance value, Sb represents the second luminance value, and Wr represents a width of a luminance value.

5. The image capturing apparatus according to any one of claims 1 to 4,
wherein the projection pattern is a pattern in which the bright portion and the dark portion having mutually different widths are periodically repeated.

6. The image capturing apparatus according to any one of claims 1 to 5,
wherein a position of the intersection is a position at which a change in curvature of a curvature distribution of the first luminance distribution and a change in curvature of a curvature distribution of the second luminance distribution are both smaller than a predetermined value and at an extreme value.

7. A three-dimensional measurement apparatus comprising the image capturing apparatus according to any one of claims 1 to 6, which measures a position and an orientation of the target object using a space encoding method.

8. A control method of an image capturing apparatus, comprising:
a projection step of projecting a first pattern or a second pattern each having a bright portion and a dark portion onto a target object as a projection pattern; and
an image capturing step of imaging the target object onto which the projection pattern is projected on an image sensor as a luminance distribution,
wherein the luminance distribution has a first luminance value corresponding to the bright portion and a second luminance value corresponding to the dark portion, the first pattern and the second pattern have an overlapping portion where positions of the bright portion or positions of the dark portion overlap, a first luminance distribution corresponding to the first pattern and a second luminance distribution corresponding to the second pattern have an intersection at which the luminance distributions have the same luminance value in the overlapping portion, and a luminance value at the intersection differs from an average value of the first luminance value and the second luminance value by a predetermined value.

9. A computer-readable storage medium storing a computer program for causing a computer to execute the steps of the control method of an image capturing apparatus according to claim 8.
